(19) United States
(12) Patent Application Publication
(10) Pub. No.: US 2026/0061446 A1
(43) Pub. Date: Mar. 5, 2026

(54) Spraying Device for Interior Repair of Wind Turbine Blade

(71) Applicant: Huaneng Jiuquan Wind Power Co., Ltd., Jiuquan (CN)

(72) Inventors: Yanzhi LI, Jiuquan (CN); Yelong WEI, Jiuquan (CN); Xiaolong SHANG, Jiuquan (CN); Chunyu GAO, Jiuquan (CN); Weiwei QIANG, Jiuquan (CN)

(21) Appl. No.: 19/385,514

(22) Filed: Nov. 11, 2025

Related U.S. Application Data
(63) Continuation of application No. PCT/CN2025/114964, filed on Aug. 15, 2025.

(30) Foreign Application Priority Data
Aug. 27, 2024 (CN) 202411180460.7

(51) Int. Cl. B05B 13/06; F03D 80/50

(52) U.S. Cl. CPC B05B 13/0636; F03D 80/502

(57) ABSTRACT

The present disclosure relates to the technical field of spraying devices, and in particular, to a spraying device for interior repair of a wind turbine blade. The spraying device for interior repair of a wind turbine blade includes: a base ring; extension arms arranged in pairs; rotation mechanisms including drive members arranged at end portions of the extension arms, and wheel that are in transmission connection to the drive members; probing mechanisms arranged on the extension arms; and spraying mechanisms arranged on the probing mechanisms; where the probing mechanisms are capable of extending in an axial direction of the base ring, and when the probing mechanisms extend, the spraying mechanism are driven to move two sides of the reinforcement plate, and then the spraying mechanisms can perform spraying on inner walls, on two sides of the reinforcement plate, of the blade body.

### CROSS-REFERENCE TO RELATED APPLICATIONS

The present application is a continuation of International Application No. PCT/CN2025/114964, filed on Aug. 15, 2025, and claims priority to Chinese Patent Application No. 202411180460.7, filed on Aug. 27, 2024, the entire disclosure of which is incorporated herein by reference.

### TECHNICAL FIELD

The present disclosure relates to the technical field of spraying devices, and in particular, to a spraying device for interior repair of a wind turbine blade.

### BACKGROUND

With sustainable development of the new energy technology, a power system is increasingly dependent on new energy sources. In response to national policies of carbon neutrality and peak carbon dioxide emissions, new energy sources in the new energy field are on the rise. However, during development of the new energy industry, in the earliest emerging wind power industry, a wind turbine faces aging maintenance in its most parts with the passage of time, such as blades. As the operation time goes by, the blade inevitably suffers bird crash, aging and glue failure at a girder, and large-area light transmission of the interior of the blade. As a result, it is necessary to use anti-corrosion paint to repair damaged parts.

As shown in FIG. 3 and FIG. 4, a blade body 1000 is provided with a reinforcement plate 1001 inside the girder to increase the strength of the girder. As a result, a spraying device becomes difficult in operation, and an existing spraying robot cannot readily enter areas, on two sides of the reinforcement plate 1001, of the interior of the blade body 1000 for the spraying operation. In view of that, the present disclosure provides a spraying device for interior repair of a wind turbine blade.

### SUMMARY

In order to solve the problem that a reinforcement plate in a blade body hinders spraying in the prior art, the present disclosure is provided.

Thus, an objective of the present disclosure is to provide a spraying device for interior repair of a wind turbine blade.

In order to solve the technical problem, the present disclosure provides the following technical solution: a spraying device for interior repair of a wind turbine blade includes: a base ring; extension arms arranged on the base ring in pairs; rotation mechanisms including drive members arranged at end portions of the extension arms, and wheels that are mounted on the extension arms and are in transmission connection to the drive members; probing mechanisms arranged on the extension arms; and spraying mechanisms arranged on the probing mechanisms; where the probing mechanisms are capable of extending in an axial direction of the base ring, and when the probing mechanisms extend, the spraying mechanisms are driven to move.

As a preferred solution of the spraying device for interior repair of a wind turbine blade of the present disclosure, the wheel is a Mecanum wheel, and the extension arm is extendable.

As a preferred solution of the spraying device for interior repair of a wind turbine blade of the present disclosure, the drive member includes a drive motor mounted on the extension arm and a transmission chain mounted between the drive motor and the wheel.

As a preferred solution of the spraying device for interior repair of a wind turbine blade of the present disclosure, the probing mechanism includes a plurality of spliced portions and inserted portions slidably arranged on the spliced portions, end portions of the spliced portions are provided with fixed shafts, and a connection pin is rotatably mounted between fixed shafts of two adjacent spliced portions.

As a preferred solution of the spraying device for interior repair of a wind turbine blade of the present disclosure, a mounting recess is provided in the spliced portion, and the inserted portion is capable of being slidably arranged at an inner side of the mounting recess; one end of the spliced portion is provided with a through recess, the through recess penetrates to the mounting recess, and a snap-fit body is arranged on the inserted portion; the other end of the spliced portion is provided with a snap-in recess; and in two adjacent spliced portions, the snap-fit body of one spliced portion is capable of penetrating the through recess to be inserted into the snap-in recess of the other spliced portion.

As a preferred solution of the spraying device for interior repair of a wind turbine blade of the present disclosure, the spraying device for interior repair of a wind turbine blade further includes: a take-up and pay-off mechanism, where the take-up and pay-off mechanism includes: a placement seat arranged on the extension arm; a winding wheel rotatably mounted on the placement seat; and a rotary pushing wheel rotatably mounted on the placement seat; and convex teeth that are distributed annularly are arranged on the rotary pushing wheel, a recess is provided in the inserted portion, and when the rotary pushing wheel rotates, the convex teeth are capable of extending to an interior of the recess to push the inserted portion to move.

As a preferred solution of the spraying device for interior repair of a wind turbine blade of the present disclosure, the placement seat includes a side plate and a support plate connected to the side plate; and the take-up and pay-off mechanism further includes a limit wheel, and the probing mechanism is wound around the limit wheel and is attached to the support plate.

As a preferred solution of the spraying device for interior repair of a wind turbine blade of the present disclosure, the rotary pushing wheel is in transmission connection to a driving gear, the winding wheel is in transmission connection to a driven gear, and the driven gear meshes with the driving gear.

As a preferred solution of the spraying device for interior repair of a wind turbine blade of the present disclosure, a transmission shaft is rotatably mounted on the side plate, and the winding wheel and the driven gear are mounted on the transmission shaft; and a connection recess is provided in the transmission shaft, a radial inner wall of the driven gear is provided with a connection block, the connection block extends to an inner side of the connection recess, and the connection block is capable of moving in an interior of the connection recess.

As a preferred solution of the spraying device for interior repair of a wind turbine blade of the present disclosure, the placement seat is mounted at the extension arm through an adjustment mechanism, and the adjustment mechanism includes: a rail fixed to the extension arm; a sliding block slidably mounted on the rail; a power member mounted on the rail; and a lead screw rotatably mounted on the rail, where the power member is rotatably connected to the lead screw, and the sliding block is in threaded connection to the lead screw.

The present disclosure has the following beneficial effects: the probing mechanism is extendable, so as to drive the spraying mechanism to move. Since a reinforcement plate divides an internal space of a blade body into two parts, a number of the probing mechanisms and a number of the spraying mechanisms are two in this example. The two probing mechanisms can convey the two spraying mechanisms to two sides of the reinforcement plate respectively, and then the spraying mechanisms can perform spraying on inner walls, on two sides of the reinforcement plate, of the blade body.

### BRIEF DESCRIPTION OF DRAWINGS

To describe technical solutions of examples of the present disclosure more clearly, accompanying drawings required for description of the examples will be briefly described below. Apparently, the accompanying drawings in the following description show merely some examples of the present disclosure, and a person of ordinary skill in the art can still derive other accompanying drawings from these accompanying drawings without creative efforts. In the figures:

FIG. 1 is a schematic overall structural diagram of a spraying device for interior repair of a wind turbine blade according to the present disclosure.

FIG. 2 is a schematic structural diagram of an extension arm and a spraying mechanism in the present disclosure.

FIG. 3 is a schematic structural diagram of a spraying device for interior repair of a wind turbine blade and a blade body in the present disclosure.

FIG. 4 is a schematic positional diagram of a spraying device for interior repair of a wind turbine blade and a reinforcement plate in the present disclosure.

FIG. 5 is a schematic structural diagram of an extension arm and an adjustment mechanism in the present disclosure.

FIG. 6 is a schematic structural diagram of a probing mechanism in the present disclosure.

FIG. 7 is a schematic internal structural diagram of a spliced portion and an inserted portion in the present disclosure.

FIG. 8 is a schematic structural diagram of a take-up and pay-off mechanism in the present disclosure.

FIG. 9 is a schematic internal structural diagram of a take-up and pay-off mechanism in the present disclosure.

FIG. 10 is a schematic structural diagram of a take-up and pay-off mechanism and a probing mechanism in the present disclosure.

FIG. 11 is a clockwise rotation state diagram of a rotary pushing wheel in the present disclosure.

FIG. 12 is an anticlockwise rotation state diagram of a rotary pushing wheel in the present disclosure.

FIG. 13 is a schematic structural diagram of a driving gear and a driven gear in the present disclosure.

FIG. 14 is a schematic structural diagram of a driven gear and a transmission shaft in the present disclosure.

Reference numerals: 100. base ring; 200. extension arm; 300. rotation mechanism; 301. drive member; 301a. drive motor; 301b. transmission chain; 302. wheel; 400. probing mechanism; 401. spliced portion; 401a. mounting recess; 401b. through recess; 401c. snap-in recess; 402. inserted portion; 402a. snap-fit body; 403. fixed shaft; 404. connection pin; 405. recess; 405a. left slope; 405b. right slope; 500. spraying mechanism; 600. take-up and pay-off mechanism; 601. placement seat; 601a. side plate; 601b. support plate; 602. winding wheel; 603. rotary pushing wheel; 603a. convex tooth; 604. limit wheel; 605. driving gear; 606. driven gear; 606a. connection block; 607. transmission shaft; 607a. connection recess; 608. driving shaft; 700. adjustment mechanism; 701. rail; 702. sliding block; 703. power member; 704. lead screw; 1000. blade body; and 1001. reinforcement plate.

### DETAILED DESCRIPTION OF THE EMBODIMENTS

To make the above objectives, features and advantages of the present disclosure clearer and more comprehensible, specific embodiments of the present disclosure will be described below in detail with reference to accompanying drawings.

Many specific details are set forth in the following description for the convenience of full understanding of the present disclosure, but the present disclosure can further be implemented in another method different from those described herein. Similar extension can be made by those skilled in the art without departing from the contents of the present disclosure, and the present disclosure is not limited by the specific examples disclosed below accordingly.

Secondly, “one example”, “an example”, or “the example” referred to herein indicates a specific feature, structure or characteristic that can be included in at least one implementation of the present disclosure. The “in an example” or “in one example” throughout this description does not indicate the same example, nor a separate or selective example mutually exclusive of other examples.

Then, the present disclosure will be described in detail with reference to the schematic diagram. When the examples of the present disclosure are described in detail, a sectional view showing a device structure will not be partially enlarged in general proportion for the convenience of description, and the schematic diagram is merely illustrative, and should not limit the protection scope of the present disclosure herein. In addition, three-dimensional spatial dimensions of a length, a width, and a depth should be included in actual production.

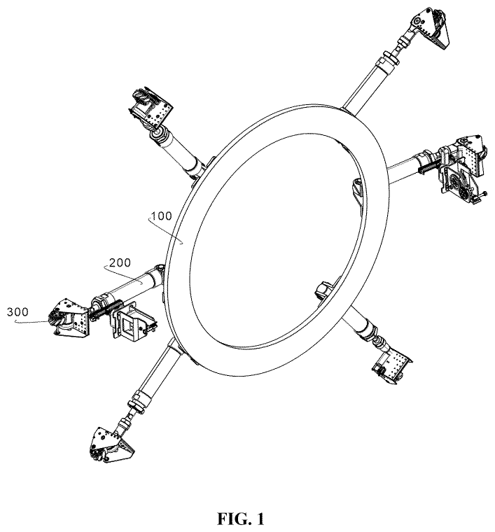

In Example 1, with reference to FIG. 1 to FIG. 5, a spraying device for interior repair of a wind turbine blade is provided. The spraying device for interior repair of a wind turbine blade includes a base ring 100, and extension arms 200 arranged on the base ring 100 in pairs. A number of pairs of the extension arms 200 are provided. In this example, three pairs of extension arms 200 are provided, and an included angle between two extension arms 200 in each pair is 180 degrees. With reference to FIG. 3, when in use, the base ring 100 is not in contact with a blade body 1000 as a whole, and the base ring 100 is in a position of an approximately concentric circle of the blade body 1000. A positional relationship between the blade body 1000 and the base ring 100 is shown in FIG. 3.

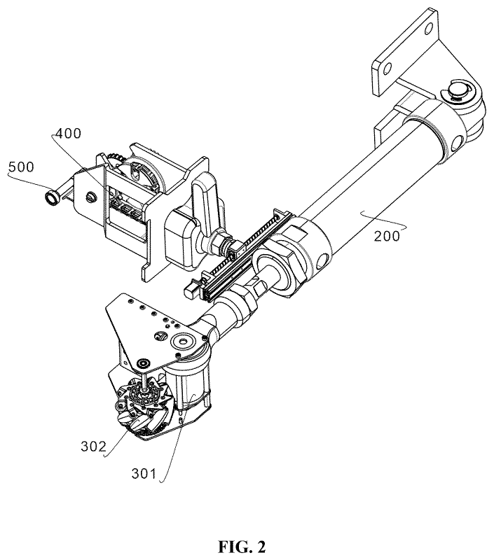

With reference to FIG. 1 and FIG. 2, the spraying device for interior repair of a wind turbine blade includes rotation mechanisms 300 including drive members 301 arranged at end portions of the extension arms 200, and wheels 302 that are mounted on the extension arms 200 and are in transmission connection to the drive members 301. With reference to FIG. 3, the extension arm 200 is in contact with an inner wall of the blade body 1000 through the rotation mechanism 300, and the drive member 301 can drive the wheel 302 to rotate, such that the entire extension arm 200 and the base ring 100 can rotate in an interior of the blade body 1000.

With reference to FIG. 2, a probing mechanism 400 is arranged on the extension arm 200, and a spraying mechanism 500 is arranged on the probing mechanism 400. The probing mechanism 400 is capable of extending in an axial direction of the base ring 100. When the probing mechanism 400 extends, the spraying mechanism 500 is driven to move.

The spraying mechanism 500 is used for spraying anticorrosive paint, and a paint container and a compressed air container may be mounted on the base ring 100. The paint container and the compressed air container are connected to the spraying mechanism 500 and used for providing the spraying mechanism 500 with a spraying raw material and spraying power.

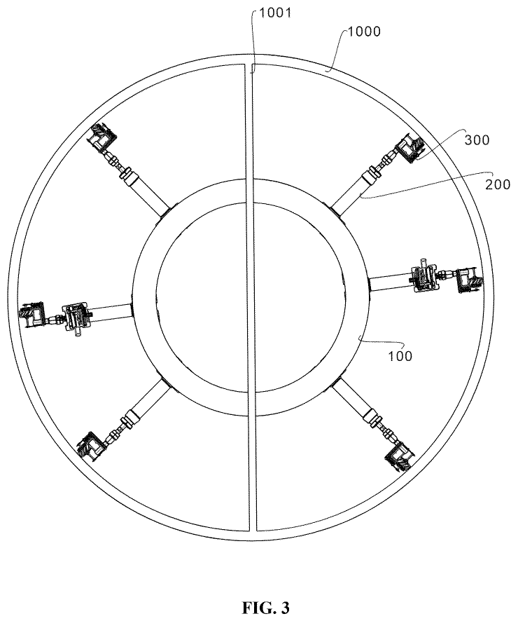

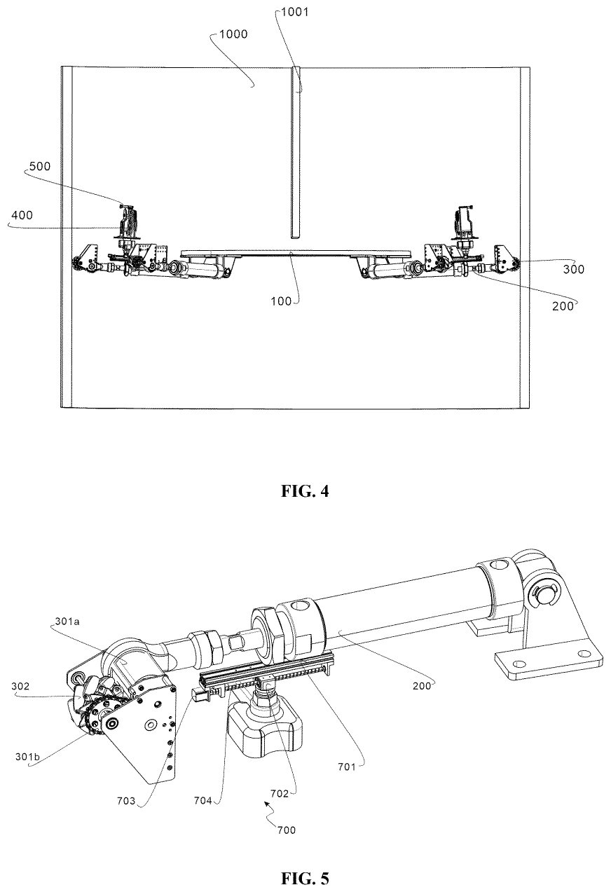

With reference to FIG. 3 and FIG. 4, in this example, the probing mechanism 400 is extendable, so as to drive the spraying mechanism 500 to move. Since a reinforcement plate 1001 exists in the interior of the blade body 1000, neither the base ring 100 nor the extension arm 200 can pass through the reinforcement plate 1001. Since the reinforcement plate 1001 divides an internal space of the blade body 1000 into two parts, a number of the probing mechanisms 400 and a number of the spraying mechanisms 500 are two in this example. The two probing mechanisms 400 can convey the two spraying mechanisms 500 to two sides of the reinforcement plate 1001 respectively, and then the spraying mechanisms 500 can perform spraying on inner walls, on two sides of the reinforcement plate 1001, of the blade body 1000. By this method, entry into the blade body 1000 can be implemented by replacing a worker, and a safety factor of maintenance of the blade body 1000 is increased.

Specifically, the wheel 302 is a Mecanum wheel, and the extension arm 200 is extendable. The wheel 302 adopts the Mecanum wheel. Thus, when a plurality of wheels 302 are in contact with the inner wall of the blade body 1000, the wheels 302 can drive the extension arms 200 and the base ring 100 to move spirally and axially, and that is, rotate around a circle center of the base ring 100 and simultaneously move in the axial direction of the blade body 1000. A position of the extension arm 200 can be adjusted through rotation, a position of the spraying mechanism 500 is adjusted accordingly, and the spraying mechanism 500 can be oriented towards different positions of the inner wall of the blade body 1000.

With reference to FIG. 3 and FIG. 4, the probing mechanism 400 extends and retracts, such that the spraying mechanism 500 can move axially parallel to a central axis of the blade body 1000. The extension arm 200 drives the spraying mechanism 500 to rotate, and the probing mechanism 400 drives the spraying mechanism 500 to move, such that the spraying mechanism 500 can be oriented towards a position to be repaired of the inner wall of the blade body 1000.

With reference to FIG. 5, further, the drive member 301 includes a drive motor 301a mounted on the extension arm 200 and a transmission chain 301b mounted between the drive motor 301a and the wheel 302. Through rotation of the drive motor 301a, the transmission chain 301b is driven to rotate, and thus the Mecanum wheel is driven to rotate.

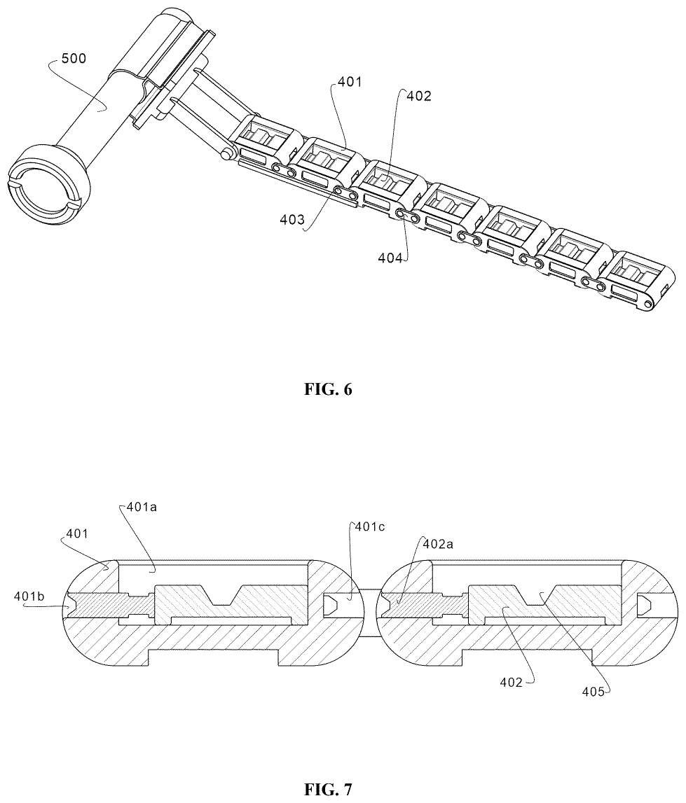

With reference to FIG. 4 to FIG. 7, Example 2 is different from the first example in that with reference to FIG. 4, in use, the base ring 100 needs to be as close as possible to the reinforcement plate 1001. In this way, when the probing mechanism 400 extends, the spraying mechanism 500 can be conveyed to a deeper position. In order to make the base ring 100 closer to the reinforcement plate 1001, an initial length of the probing mechanism 400 needs to be short enough. In this way, when the base ring 100 rotates to approach the reinforcement plate 1001, the probing mechanism 400 does not interfere with the reinforcement plate 1001. Thus, with reference to FIG. 6, in this example, the probing mechanism 400 includes a plurality of spliced portions 401 and inserted portions 402 slidably arranged on the spliced portion 401, end portions of the spliced portions 401 are provided with fixed shafts 403, and a connection pin 404 is rotatably mounted between fixed shafts 403 of two adjacent spliced portions 401. Two adjacent spliced portions 401 are capable of being connected through the inserted portion 402. The connection pin 404 is rotatably connected to the fixed shaft 403. When the inserted portions 402 of the spliced portions 401 can be inserted into adjacent spliced portions 401, the plurality of spliced portions 401 are bendably arranged, such that an entire length of the probing mechanism 400 composed of the spliced portions 401 is small before the probing mechanism extends, and the base ring 100 can be as close as possible to the reinforcement plate 1001. During extending, the inserted portions 402 of the spliced portions 401 are inserted into inner sides of the adjacent spliced portions 401. Thus, the plurality of spliced portions 401 can be arranged linearly, the entire length is increased, the spraying mechanisms 500 are driven to move, and the spraying mechanisms 500 extend into the two sides of the reinforcement plate 1001.

Specifically, with reference to FIG. 7, a mounting recess 401a is provided in the spliced portion 401, and the inserted portion 402 is capable of being slidably arranged at an inner side of the mounting recess 401a. One end of the spliced portion 401 is provided with a through recess 401b, the through recess 401b penetrates to the mounting recess 401a, and a snap-fit body 402a is arranged on the inserted portion 402. The other end of the spliced portion 401 is provided with a snap-in recess 401c. In two adjacent spliced portions 401, the snap-fit body 402a of one spliced portion 401 is capable of penetrating the through recess 401b to be inserted into the snap-in recess 401c of the other spliced portion 401.

When two adjacent spliced portions 401 are in a linear arrangement state, the inserted portion 402 moves in a direction towards the through recess 401b in an interior of the mounting recess 401a, and the snap-fit body 402a can be driven to penetrate the through recess 401b, to be inserted into the snap-in recess 401c of the adjacent spliced portion 401. Thus, the two spliced portions 401 can keep the linear arrangement state without bending, and the spraying mechanism 500 is stably supported.

The remaining structures are the same as structures of Example 1.

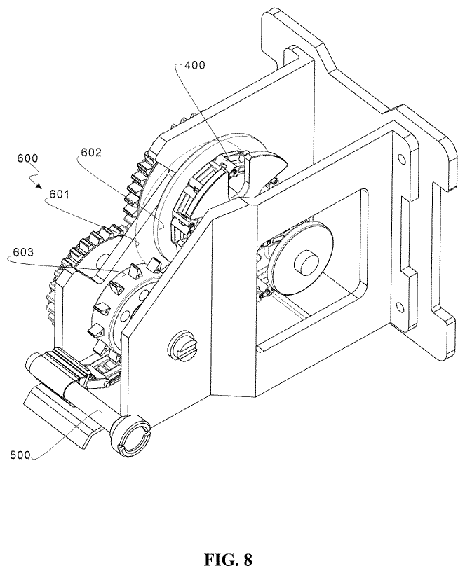

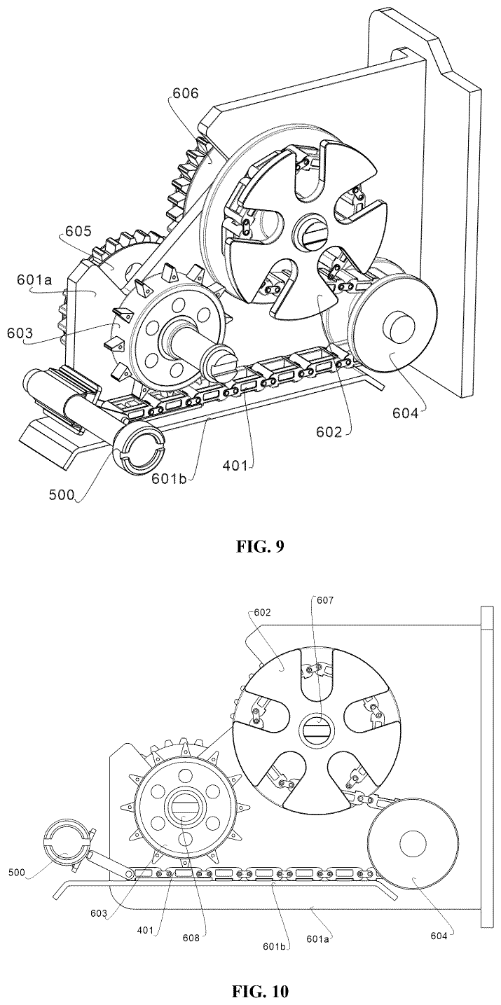

With reference to FIG. 8 to FIG. 12, Example 3 is different from the examples described above in that with reference to FIG. 8 and FIG. 9, the spraying device for interior repair of a wind turbine blade further includes: a take-up and pay-off mechanism 600. The take-up and pay-off mechanism includes: a placement seat 601 arranged on the extension arm 200; a winding wheel 602 rotatably mounted on the placement seat 601; and a rotary pushing wheel 603 rotatably mounted on the placement seat 601. Convex teeth 603a that are distributed annularly are arranged on the rotary pushing wheel 603, a recess 405 is provided in the inserted portion 402, and when the rotary pushing wheel 603 rotates, the convex teeth 603a are capable of extending to an interior of the recess 405 to push the inserted portion 402 to move. The placement seat 601 is used for providing a mounting position. A motor structure may be arranged on the placement seat 601 and is in transmission connection to the rotary pushing wheel 603, and the motor structure may drive the rotary pushing wheel 603 to rotate. As shown in FIG. 11, the recess 405 has two slopes adjacent to a bottom of the recess, that is, a left slope 405a and a right slope 405b. When the rotary pushing wheel 603 rotates clockwise, the convex teeth 603a abut against the left slope 405a, and push the inserted portion 402 to move at first through the left slope 405a, and then the snap-fit body 402a is inserted into the snap-in recess 401c of the adjacent spliced portion 401. As the rotary pushing wheel 603 continues rotating clockwise, the spliced portions 401 may be pushed to move in a direction far away from the extension arm 200 through the inserted portions 402. Along with clockwise rotation of the rotary pushing wheel 603, the spliced portions 401 can be inserted one by one through the spliced portions 402, and the inserted spliced portions 401 extend out of the interior of the placement seat 601. Thus, the probing mechanism 400 extends to extent the spraying mechanism 500.

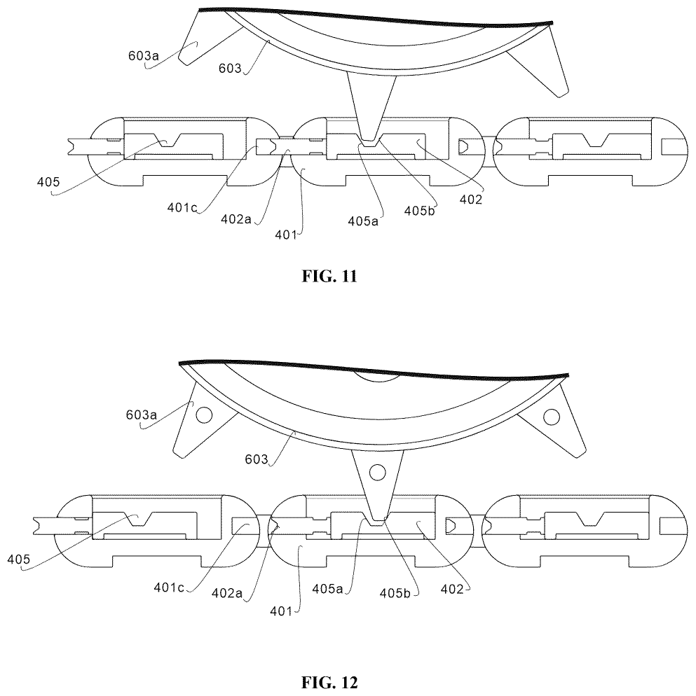

As shown in FIG. 12, when the rotary pushing wheel 603 rotates anticlockwise, the convex teeth 603a abut against the right slope 405b, and push the inserted portions 402 to move at first through the right slope 405b, and then the snap-fit body 402a is separated from the interior of the snap-in recess 401c of the adjacent spliced portion 401. Along with anticlockwise rotation of the rotary pushing wheel 603, inserted relationships between the spliced portions 401 can be released one by one, such that the spliced portions 401 with the inserted relationships released can be wound around an outer side of the winding wheel 602.

A magnetic structure may be arranged at a recess wall, farthest from the through recess 401b, of the recess 405. When the inserted portion 402 retracts, the magnetic structure can provide particular magnetic force for the inserted portion 402, such that the inserted portion 402 can keep a position.

Through the solution, when the probing mechanism 400 needs to extend to push the spraying mechanism 500, the motor structure drives the rotary pushing wheel 603 to rotate clockwise. Then, the spliced portions 401 can extend out of the interior of the placement seat 601 one by one in a linear arrangement state, so as to push the spraying mechanism 500.

After spraying on the inner wall of the blade body 1000 is completed, the motor structure drives the rotary pushing wheel 603 to rotate anticlockwise. Then the splicing relationship between the spliced portions 401 can be released, an angle between adjacent spliced portions 401 can be changed, and the spliced portion can be wound around the outer side of the winding wheel 602.

Specifically, with reference to FIG. 9 and FIG. 10, the placement seat 601 includes a side plate 601a and a support plate 601b connected to the side plate 601a. The take-up and pay-off mechanism 600 further includes a limit wheel 604, and the probing mechanism 400 is wound around the limit wheel 604 and is attached to the support plate 601b. The rotary pushing wheel 603 and the winding wheel 602 are rotatably mounted on the side plate 601a, and the support plate 601b can form support below the spliced portion 401 when the rotary pushing wheel 603 is in contact with and pushes the inserted portion 402. Thus, when each spliced portion 401 penetrates a gap between the support plate 601b and the rotary pushing wheel 603, the each spliced portion is pushed by the convex teeth 603a.

The limit wheel 604 is used for guiding a travel path of the spliced portion 401. Thus, the spliced portion 401 unwound from the winding wheel 602 reaches a position of being attached to the support plate 601b under guidance of the limit wheel 604.

The remaining structures are the same as structures of Example 2.

With reference to FIG. 9 and FIG. 13, Example 4 is different from the examples described above in that the rotary pushing wheel 603 is in transmission connection to a driving gear 605, the winding wheel 602 is in transmission connection to a driven gear 606, and the driven gear 606 meshes with the driving gear 605. The rotary pushing wheel 603 is rotatably mounted on the side plate 601a through a driving shaft 608, and the motor structure drives the driving shaft 608 to rotate, so as to drive the rotary pushing wheel 603 to rotate synchronously. The driving gear 605 is also mounted on the driving shaft 608. When the driving shaft 608 rotates, the driving gear 605 is driven to rotate synchronously. The driving gear 605 may drive the driven gear 606 to rotate, and then the winding wheel 602 rotates. Thus, the winding wheel 602 also rotates. When the spliced portion 401 is inserted and extended, the winding wheel 602 rotates to unwind the spliced portion 401 wound around the outer side. When the spliced portion 401 retracts and is released from an inserted state, the winding wheel 602 rotates to rewind the retracted spliced portion 401.

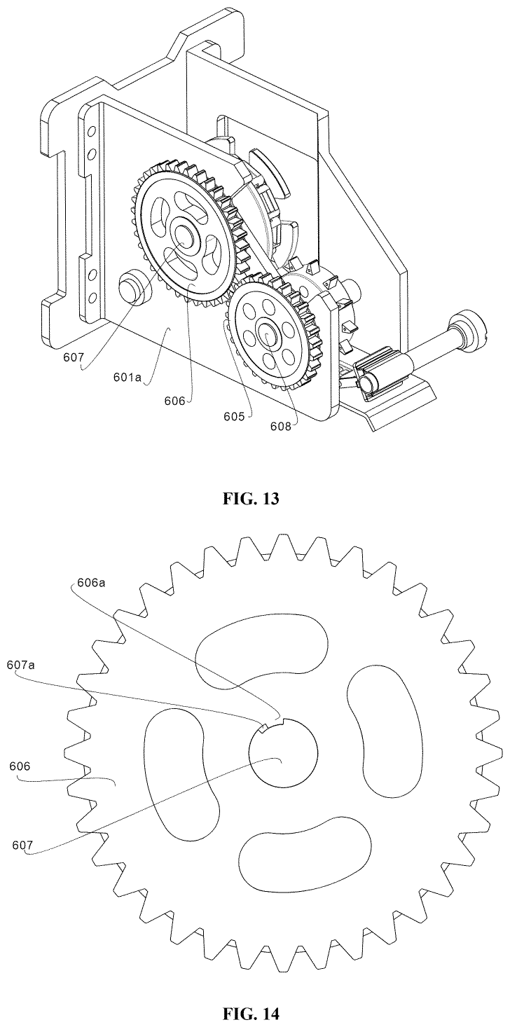

Specifically, with reference to FIG. 13 and FIG. 14, a transmission shaft 607 is rotatably mounted on the side plate 601a, and the winding wheel 602 and the driven gear 606 are mounted on the transmission shaft 607. A connection recess 607a is provided in the transmission shaft 607, a radial inner wall of the driven gear 606 is provided with a connection block 606a, the connection block 606a extends to an inner side of the connection recess 607a, and the connection block 606a is capable of moving in an interior of the connection recess 607a.

During switch of two states of extending and retracting, the rotary pushing wheel 603 switches from clockwise rotation to anticlockwise rotation. If rotation of the winding wheel 602 during switch may pulls the spliced portion 401 during the switch, and the spliced portion 401 is displaced without push of the convex tooth 603a, the convex teeth 603a are caused to rotate anticlockwise, and fail to be in contact with to the right slope 405b. In view of that, the connection recess 607a and the connection block 606a are provided. The connection recess 607a is provided in a radial side surface of the transmission shaft 607, and the connection block 606a is at the inner wall of the driven gear 606. In this way, when the driven gear 606 rotates clockwise, the connection block 606a abuts against a first end of the connection recess 607a, to push the transmission shaft 607 to rotate clockwise. When the driven gear rotates anticlockwise, the connection block 606a abuts against a second end of the connection recess 607a, to push the transmission shaft 607 to rotate anticlockwise. However, when the driven gear 606 is switched from clockwise rotation to anticlockwise rotation, the connection block 606a needs to reach the second end from the first end before pushing the transmission shaft 607, which is also required for switch from the anticlockwise rotation to the clockwise rotation. Thus, when a rotation direction of the rotary pushing wheel 603 is switched, it can be ensured that the winding wheel 602 does not rotate within a particular angle of rotation, the convex teeth 603a can smoothly switch between two states of abutting against the left slope 405a or abutting against the right slope 405b, and the entire device can stably operate.

The remaining structures are the same as structures of Example 3.

With reference to FIG. 2 and FIG. 5, Example 5 is different from the examples described above in that the placement seat 601 is mounted at the extension arm 200 through an adjustment mechanism 700, and the adjustment mechanism 700 includes: a rail 701 fixed to the extension arm 200; a sliding block 702 slidably mounted on the rail 701; a power member 703 mounted on the rail 701; and a lead screw 704 rotatably mounted on the rail 701. The power member 703 is rotatably connected to the lead screw 704, and the sliding block 702 is in threaded connection to the lead screw 704.

The rail 701 is arranged in an axial direction of the extension arm 200, and the sliding block 702 slides on the rail 701. Thus, a position of the spraying mechanism 500 can be adjusted along the extension arm 200, a distance between the spraying mechanism 500 and the inner wall of the blade body 1000 is adjusted, and adapting to different spraying requirements is achieved.

The sliding block 702 is driven by the power member 703. The power member 703 can adopt a motor, and drive the lead screw 704 to rotate, so as to adjust a position of the sliding block 702. Further, the distance between the spraying mechanism 500 and the inner wall of the blade body 1000 is adjusted.

The remaining structures are the same as structures of Example 4.

It is important to note that the configuration and arrangement of the present disclosure shown in various illustrative implementation solutions are merely illustrative. Although merely a few implementation solutions have been described in detail in the disclosed contents, those referring to the disclosed contents should readily understand that many modifications (for example, sizes, scales, structures, shapes, and proportions of various elements, as well as changes in parameter values (such as a temperature and a pressure), mounting arrangement, use of materials, color, and orientation) can be made without materially departing from the novel teachings and advantages of the subject matter described in the present disclosure. For example, an element shown as being integrally formed can be composed of a plurality of parts or elements, the position of the element may be inverted or otherwise changed, and the nature, numbers, or positions of discrete elements can be modified or changed. Thus, all such modifications are intended to be included within the scope of the present disclosure. The order or sequence of steps of any process or method can be changed or re-ranked according to an alternative implementation solution. In the claims, any “device and function” clause is intended to cover the structure described herein that performs the function, which is structurally equivalent and further an equivalent structure. Other substitutions, modifications, changes, and omissions can be made in the design, operating conditions, and arrangement of the illustrative implementation solutions without departing from the scope of the present disclosure. Thus, the present disclosure is not limited to specific implementation solutions, but extends to various modifications that still fall within the scope of the appended claims.

Further, in order to provide concise description of the illustrative implementation solutions, all features of an actual implementation solution (that is, those features that are not related to an optional mode currently considered for performing the present disclosure or those features that are not related to implementing of the present disclosure) may not be described.

It should be understood that in the development process of any actual embodiment, in any engineering or design project, a large number of specific embodiment decisions can be made. Such development effort may be complicated and time-consuming, but will be routine work of design, manufacture and production without too many experiments for those of ordinary skill benefiting from the present disclosure.

It should be noted that the examples described above are merely intended to describe the technical solutions of the present disclosure rather than limiting same. Although the present disclosure has been described in detail with reference to the preferred examples, those skilled in the art should understand that modifications or equivalent substitutions can be made to the technical solutions of the present disclosure without departing from the spirit and scope of the technical solutions of the present disclosure, and should fall within the scope of the claims of the present disclosure.

What is claimed is:

1. A spraying device for interior repair of a wind turbine blade, comprising:
a base ring;
extension arms arranged on the base ring in pairs;
rotation mechanisms comprising drive members arranged at end portions of the extension arms, and wheels that are mounted on the extension arms and are in transmission connection to the drive members;
probing mechanisms arranged on the extension arms; and
spraying mechanisms arranged on the probing mechanisms; wherein
the probing mechanisms are capable of extending in an axial direction of the base ring, and when the probing mechanisms extend, the spraying mechanism are driven to move.

2. The spraying device for interior repair of a wind turbine blade according to claim 1, wherein the wheel is a Mecanum wheel, and the extension arm is extendable.

3. The spraying device for interior repair of a wind turbine blade according to claim 2, wherein the drive member comprises a drive motor mounted on the extension arm and a transmission chain mounted between the drive motor and the wheel.

4. The spraying device for interior repair of a wind turbine blade according to claim 3, wherein the probing mechanism comprises a plurality of spliced portions and inserted portions slidably arranged on the spliced portions, end portions of the spliced portions are provided with fixed shafts, and a connection pin is rotatably mounted between fixed shafts of two adjacent spliced portions; and
two adjacent spliced portions are capable of being connected through the inserted portion.

5. The spraying device for interior repair of a wind turbine blade according to claim 4, wherein a mounting recess is provided in the spliced portion, and the inserted portion is capable of being slidably arranged at an inner side of the mounting recess;
one end of the spliced portion is provided with a through recess, the through recess penetrates to the mounting recess, and a snap-fit body is arranged on the inserted portion;
the other end of the spliced portion is provided with a snap-in recess; and
in two adjacent spliced portions, the snap-fit body of one spliced portion is capable of penetrating the through recess to be inserted into the snap-in recess of the other spliced portion.

6. The spraying device for interior repair of a wind turbine blade according to claim 5, further comprising: a take-up and pay-off mechanism, wherein
the take-up and pay-off mechanism comprises: a placement seat arranged on the extension arm;
a winding wheel rotatably mounted on the placement seat; and
a rotary pushing wheel rotatably mounted on the placement seat; and
convex teeth that are distributed annularly are arranged on the rotary pushing wheel, a recess is provided in the inserted portion, and when the rotary pushing wheel rotates, the convex teeth are capable of extending to an interior of the recess to push the inserted portion to move.

7. The spraying device for interior repair of a wind turbine blade according to claim 6, wherein the placement seat comprises a side plate and a support plate connected to the side plate; and
the take-up and pay-off mechanism further comprises a limit wheel, and the probing mechanism is wound around the limit wheel and is attached to the support plate.

8. The spraying device for interior repair of a wind turbine blade according to claim 7, wherein the rotary pushing wheel is in transmission connection to a driving gear, the winding wheel is in transmission connection to a driven gear, and the driven gear meshes with the driving gear.

9. The spraying device for interior repair of a wind turbine blade according to claim 8, wherein a transmission shaft is rotatably mounted on the side plate, and the winding wheel and the driven gear are mounted on the transmission shaft; and
a connection recess is provided in the transmission shaft, a radial inner wall of the driven gear is provided with a connection block, the connection block extends to an inner side of the connection recess, and the connection block is capable of moving in an interior of the connection recess.

10. The spraying device for interior repair of a wind turbine blade according to claim 9, wherein the placement seat is mounted at the extension arm through an adjustment mechanism, and the adjustment mechanism comprises:
a rail fixed to the extension arm;
a sliding block slidably mounted on the rail;
a power member mounted on the rail; and
a lead screw rotatably mounted on the rail, wherein the power member is rotatably connected to the lead screw, and the sliding block is in threaded connection to the lead screw.
